(19) United States
(12) Patent Application Publication
(10) Pub. No.: US 2018/0278590 A1
(43) Pub. Date: Sep. 27, 2018

(54) SECURITY SELF-AWARE SPECTROMETER

(71) Applicant: Ocean Optics, Inc., Largo, FL (US)

(72) Inventors: Kevin C. Moody, Hillsborough, FL (US); Ken Wayne Sallings, Hernando, FL (US)

(21) Appl. No.: 15/935,141

(22) Filed: Mar. 26, 2018

Related U.S. Application Data
(60) Provisional application No. 62/477,177, filed on Mar. 27, 2017.

(51) Int. Cl. H04L 29/06; H04L 9/14; H04L 9/08; H04L 9/32; H04L 9/30

(52) U.S. Cl. CPC H04L 63/0478; H04L 63/166; H04L 9/30; H04L 9/0861; H04L 9/3263; H04L 9/14

(57) ABSTRACT

A security self-aware system for multi-bus spectrometers that ensures that only one ‘open’ or non-encrypted connection can be established, and that all other connections then must communicate over a TLS/SSL encrypted layer or not be connected is disclosed.

### CROSS-REFERENCE TO RELATED APPLICATION

The present application claims the benefit of previously filed co-pending Provisional Patent Application Ser. No. 62/477,177 filed on Mar. 27, 2017.

### FIELD OF THE INVENTION

The method of this disclosure belongs to the field of spectrometer systems. More specifically, it is a new security system for multi-bus spectrometers.

### BACKGROUND OF THE INVENTION

Spectrometers with several buses capable of communicating to client devices such as PCs are now commercially available. These buses typically include USB, Ethernet, and Wi-Fi connections. The disclosure of this application applies only to remote communications, i.e. those using Ethernet and Wi-Fi, not USB. Keeping remote multiple bus connections secure when several users have access to the multi-bus spectrometer has become a concern as these multi-bus spectrometers proliferate in insecure environments. The system of this disclosure ensures that only one ‘open’ (non-encrypted) remote connection can be established, and that all other remote connections then must communicate over a Transport Layer Security/Secure Sockets Layer (TLS/SSL) encrypted layer or not be connected.

Thus there is a need to have a security self-aware spectrometer system as disclosed herein.

### BRIEF SUMMARY OF THE INVENTION

The security self-aware spectrometer system of this disclosure ensures that only one ‘open’ (non-encrypted) remote connection can be established, and that all other remote connections then must communicate over a Transport Layer Security/Secure Sockets Layer (TLS/SSL) encrypted layer or not be connected.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a typical Open Systems Interconnection (OSI) Network Model used by the preferred embodiment security self-aware spectrometer system; and,

FIG. 2 shows a flow chart of the connection process of the preferred embodiment of the security self-aware spectrometer system.

### DESCRIPTION OF THE PREFERRED EMBODIMENT

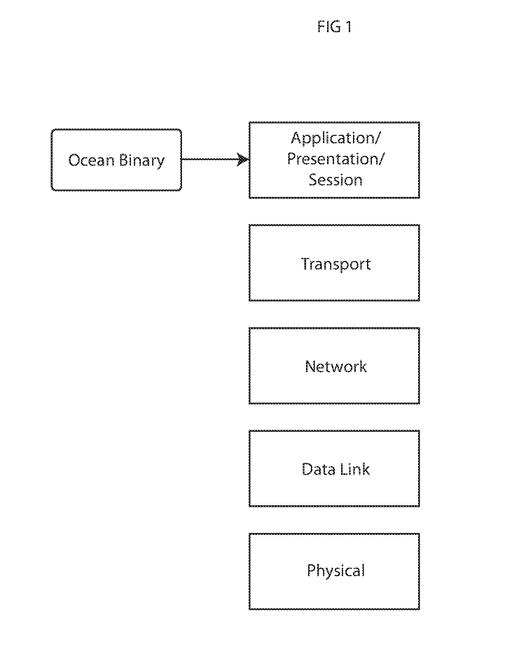

The security self-aware spectrometer protocol system of this disclosure, (included as part of the communications protocol identified in FIG. 1 as Ocean Binary), is inserted in the Application or Presentation layer depicted by the Open Systems Interconnection (OSI) Network Model shown in FIG. 1. The OSI Network Model is well known by those skilled in the art.

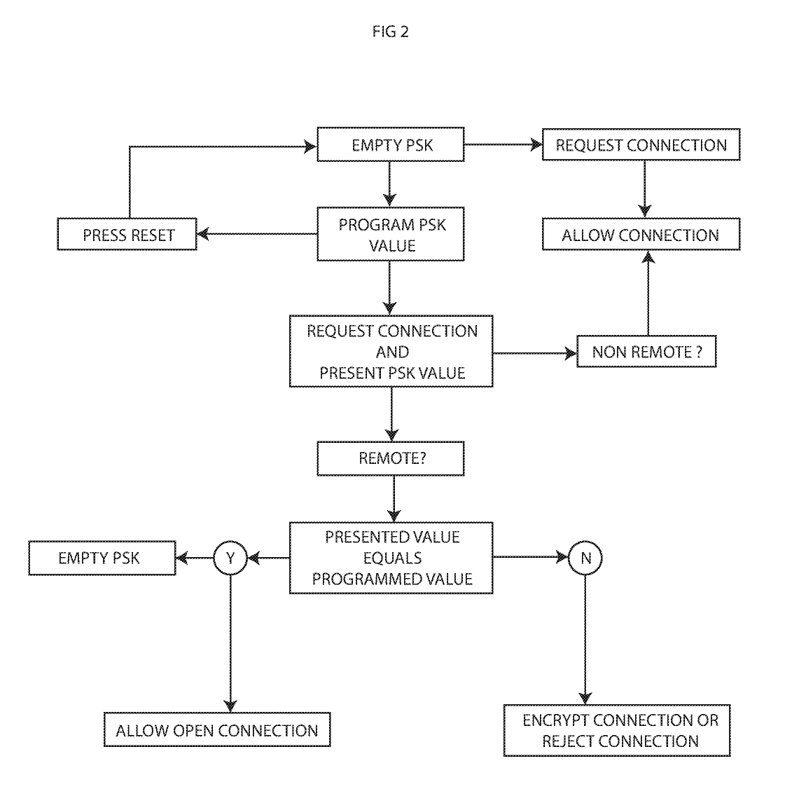

The preferred embodiment security self-aware spectrometer protocol system of this disclosure will hold a place, typically in non-volatile memory, called a private session key (PSK). This PSK can be of any arbitrary byte length between 24 or 32 bytes. As shown in FIG. 2 this PSK is initially empty until programmed with a value. It may also return to empty if the physical reset button is pressed on the device. If the PSK location on the spectrometer is programmed to a value, then any Ethernet or WiFi connection (remote connection) must present this same PSK in its binary protocol header area to establish communications and become the sole qualified recipient of an open (non-encrypted) remote connection. Connections can be made without this PSK but received data from the device to another non-qualified open channel will be ignored and may result in a timeout condition.

Other remote connections can be made but only via Transport Layer Security/Secure Sockets Layer (TLS/SSL) where a trusted certificate, public and private key, are involved in creating a session key. This type of remote connection lacks the speed performance of an ‘open’ connection. Once the session key is established, performance is somewhat maintained because only that key is used for symmetrical encryption with all following transactions. Another avenue would be that no TLS/SSL connection is permitted once the single ‘open’ connection is established, effectively allowing only one connection to spectrometer.

In conclusion, this design requires a simple identical match be performed between a spectrometer and one other network remote connection to establish an open (non-encrypted) channel for communications.

Since certain changes may be made in the above described security self-aware system for a spectrometer without departing from the scope of the invention herein involved, it is intended that all matter contained in the description thereof or shown in the accompanying figures shall be interpreted as illustrative and not in a limiting sense.

What is claimed is:

1. A spectrometer user connection method that ensures that only one non-encrypted remote connection can be established and that all additional remote connections then must communicate over a Transport Layer Security/Secure Sockets Layer (TLS/SSL) encrypted layer or not be connected comprising:
first programming a private session key in said spectrometer's connection protocol system with a value;
said value capable of being reset to no value;
then a first user requesting a connection to said spectrometer using a remote connection presenting said private session key value in said remote connection's binary protocol header area;
if said presented value equals said programmed value then said spectrometer establishing a non-encrypted remote connection and said first user becoming the sole user of said non-encrypted remote connection; and,
once said non-encrypted remote connection is made then additional users requesting connections to said spectrometer can only be connected to said spectrometer through use of a Transport Layer Security/Secure Sockets Layer (TLS/SSL) connection wherein a trusted certificate, public and private key, are used in creating a session key allowing connection.

2. The spectrometer user connection method of claim 1 wherein no additional user connections are allowed after said first user non-encrypted remote connection is made.
